(19) United States
(12) Patent Application Publication
(10) Pub. No.: US 2022/0075103 A1
(43) Pub. Date: Mar. 10, 2022

(54) REFLECTOR

(71) Applicant: NALUX CO., LTD., Osaka (JP)

(72) Inventor: Tomohito KUWAGAITO, Osaka (JP)

(73) Assignee: NALUX CO., LTD., Osaka (JP)

(21) Appl. No.: 17/528,398

(22) Filed: Nov. 17, 2021

Related U.S. Application Data
(63) Continuation of application No. PCT/JP2021/004067, filed on Feb. 4, 2021.
(60) Provisional application No. 62/979,555, filed on Feb. 21, 2020.

(51) Int. Cl. G02B 5/124; G02B 5/04

(52) U.S. Cl. CPC G02B 5/124; G02B 5/045

(57) ABSTRACT

The reflector is provided with plural reflector units. Each reflector unit is shaped as a prism or a cylinder provided with a retroreflective structure at one end, the retroreflective structure is configured to reflect incident rays from the other end of the prism or the cylinder in a direction of incidence, and in a reference cross section of the reflector unit, the reference cross section containing the central axis of the prism or the cylinder and the reference cross section being determined such that the shape of the retroreflective structure is line-symmetric with respect to the central axis in the reference cross section, the shape of a light receiving surface at the other end is line-symmetric with respect to the central axis and has a portion inclined with respect to a direction perpendicular to the central axis in the reflector unit.

### CROSS REFERENCE TO RELATED APPLICATION

This is a Continuation of International Patent Application No. PCT/JP2021/004067 filed Feb. 4, 2021, which designates the U.S., and which claims priority from U.S. Provisional Patent Application No. 62/979,555, dated Feb. 21, 2020. The contents of these applications are hereby incorporated by reference.

### TECHNICAL FIELD

The present invention relates to a reflector provided with a retroreflective structure.

### BACKGROUND ART

A retroreflective structure refers to a structure that reflects an incident ray of light in a direction of incidence. An example of the retroreflective structure is a corner cube. A corner cube incudes three flat surfaces that are orthogonal to one another and form a vertex of a cube. The three flat surfaces are configured so as to reflect an incident ray of light to a direction of incidence. A reflector is made by combining plural corner cubes.

In some applications of reflectors, there is a need to reflect an incident ray of light not in a direction of incidence, but in a direction at a predetermined angle with respect to the direction of incidence. In order to fill such a need, for example, a reflector in which angles between the three flat surfaces of a corner cube are adjusted such that an incident ray of light is reflected in a direction at a predetermined angle with respect to the direction of incidence has been developed (for example patent document 1, JPH1011000(A)).

A reflector provided with plural corner cubes is produced by injection molding using a mold. A mold for a reflector is configured by combining plural pins, each pin being in a bar shape. At an end of each pin, surfaces corresponding to two surfaces of the three flat surfaces are provided. The mold for a reflector provided with plural corner cubes arranged without spaces therebetween is formed with the ends of the combined plural pins.

When angles between the three flat surfaces of a corner cube are adjusted according to a predetermined angle with respect to the direction of incidence, it is necessary to design the shape of pins and produce the pins according to each value of the predetermined angle. It requires a lot of time and costs to design the shape of pins and produce the pins according to each value of a predetermined angle that depends on an application. So far, however, a reflector that reflects an incident ray of light in a direction at a predetermined angle with respect to the direction of incidence and that can be produced easily and at low costs according to the predetermined angle has not been developed.

Accordingly, there is a need for a reflector that reflects an incident ray of light in a direction at a predetermined angle with respect to a direction of incidence and that can be produced easily and at low costs according to the predetermined angle.

### PRIOR ART DOCUMENT

### Patent Document

Patent document 1: JPH1011000(A)

The object of the present invention is to provide a reflector that reflects an incident ray of light in a direction at a predetermined angle with respect to a direction of incidence and that can be produced easily and at low costs according to the predetermined angle.

### SUMMARY OF THE INVENTION

A reflector according to the present invention is provided with plural reflector units. Each reflector unit is shaped as a prism or a cylinder provided with a retroreflective structure at one end, the is configured to reflect incident rays from the other end of the prism or the cylinder in a direction of incidence, and in a reference cross section of the reflector unit, the reference cross section containing the central axis of the prism or the cylinder and the reference cross section being determined such that the shape of the retroreflective structure is line-symmetric with respect to the central axis in the reference cross section, the shape of a light receiving surface at the other end is line-symmetric with respect to the central axis and has a portion inclined with respect to a direction perpendicular to the central axis in the reflector unit.

With a reflector according to the present invention, a direction of a reflected ray of light can be changed by changing the shape of a light receiving surface alone while the shape of retroreflective structures is kept unchanged. Accordingly, a reflector according to the present invention can be produced easily and at low costs according to a predetermined angle that depends on an application.

In the reflector according to a first embodiment of the present invention, in the reference cross section of each reflector unit, when an angle measured counterclockwise that the light receiving surface forms with a direction perpendicular to the central axis at a first point on the light receiving surface is represented as θ, an angle measured clockwise that the light receiving surface forms with a direction perpendicular to the central axis at a second point on the light receiving surface, the first point and the second point being line-symmetric with respect to the central axis, is θ, and the reflector unit is configured to reflect incident rays onto the prism or the cylinder in a direction inclined with respect to the central axis by an angle determined depending on θ.

In the reflector according to a second embodiment of the present invention, at least a certain number of the plural reflector units are combined with one another such that respective reference cross sections agree with or are made parallel to one another, and the shape of the light receiving surface is uniform in the reference cross section of any reflector unit of the certain number of the plural reflector units and in cross sections parallel to the reference cross section.

In the reflector according to a third embodiment of the present invention, each reflector unit is provided with a corner cube as a retroreflective structure at one end of the prism having a cross section in the shape of a regular hexagon, and the reference cross section of the reflector is determined to be orthogonal to two opposite sides of the regular hexagon.

In the reflector according to a fourth embodiment of the present invention, each reflector unit is provided with a ball lens as a retroreflective structure at one end of the cylinder.

In the reflector according to a fifth embodiment of the present invention, in the reference cross section, the shape of the light receiving surface in each reflector unit is a combination of line segments, the combination being line-symmetric with respect to the central axis.

By the reflector of the present embodiment, a reflected rays of light that are inclined by a predetermined angle from the central axis can be generated. The predetermined angle is determined by an angle of inclination of a line segment to the central axis at the point of incidence of an incident ray.

In the reflector according to a sixth embodiment of the present invention, in the reference cross section, the shape of the light receiving surface in each reflector unit is a curve that is line-symmetric with respect to the central axis.

By the reflector of the present embodiment, reflected rays of light in a predetermined range of angle, the range being determined by the curve, can be generated.

The reflector according to a seventh embodiment of the present invention includes plural types of light receiving surfaces that are differently shaped.

By the reflector of the present embodiment, reflected rays of light that are at several values of angle with respect to the central axis can be generated.

### BRIEF DESCRIPTION OF DRAWINGS

FIG. 1 shows a plan view, an A-A cross sectional view and a B-B cross sectional view of a reflector according to an embodiment of the present invention;

FIG. 2 is a perspective view of a corner cube that is a retroreflective structure of a reflector unit according to an embodiment of the present invention;

FIG. 3 is a plan view of the corner cube that is a retroreflective structure of the reflector unit according to the embodiment of the present invention;

FIG. 4 shows the reference cross section of a reflector unit according to an embodiment of the present invention;

FIG. 5 shows the reference cross section of a reflector unit according to an embodiment of the present invention;

FIG. 6 is a drawing for illustrating an angle of a ray leaving the reflector unit with respect to a direction parallel to the reference axis;

FIG. 7 is a drawing for illustrating a reflector according to an embodiment of the present invention;

FIG. 8 shows a reference cross section of a reflector unit of Example 1;

FIG. 9 shows a reference cross section of a reflector unit of Example 2;

FIG. 10 shows a reference cross section of a reflector unit of Example 3;

FIG. 11 shows relationships between angle that a reflected ray of an incident ray parallel to the reference axes of a reflector forms with a direction parallel to the reference axes in a reference cross section (for example, B-B cross section in FIG. 1) containing central axes of the reflector and luminous intensity of the reflected ray;

FIG. 12 shows a distribution of luminous intensity of reflected light in the case that the light receiving surface is flat without a diffusing structure;

FIG. 13 shows a distribution of luminous intensity of reflected light of Example 1 and Example 2;

FIG. 14 shows a distribution of luminous intensity of reflected light of Example 3;

FIG. 15 is a drawing for illustrating a reflector of Example 4;

FIG. 16 shows a common reference cross section of plural reflector units provided with the two types of diffusing structures of Example 4;

FIG. 17 shows relationships between angle that a reflected ray of an incident ray parallel to the reference axes of the reflector forms with a direction parallel to the reference axes in a reference cross section containing central axes of the reflector and luminous intensity of the reflected ray; and

FIG. 18 shows a distribution of luminous intensity of reflected light of Example 4.

### DESCRIPTION OF EMBODIMENTS

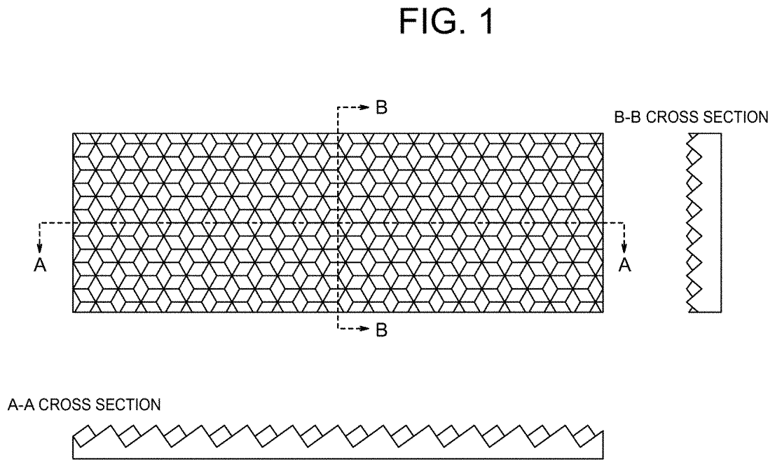

FIG. 1 shows a plan view, an A-A cross sectional view and a B-B cross sectional view of a reflector according to an embodiment of the present invention. The reflector has a shape obtained by combining reflector units without spaces between them, each of the reflector units having a regular hexagonal cross section as shown in the plan view. A reflector unit refers to a component of a reflector, the component having a retroreflective function. A reflector is formed as a set of reflector units.

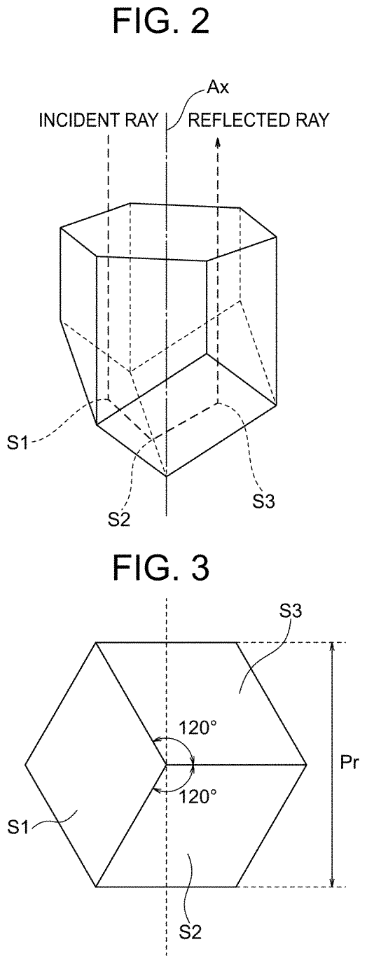

FIG. 2 is a perspective view of a corner cube that is a retroreflective structure of a reflector unit according to an embodiment of the present invention.

FIG. 3 is a plan view of the corner cube that is a retroreflective structure of the reflector unit according to the embodiment of the present invention.

The corner cube of the reflector unit is shaped in such a way that in a prism a cross section of which is regular hexagonal, three flat surfaces that traverse three sets of two adjacent side surfaces are configured so as to be orthogonal to one another and to form a vertex of a cube, and the three flat surfaces are configured so as to reflect an incident ray into the prism in a direction of incidence. In FIG. 2 and FIG. 3, the three flat surfaces are represented as S1, S2 and S3. A ray of light that is incident onto one of the three flat surfaces is reflected in the direction of incidence after having been reflected by the other two flat surfaces. The central axis of the prism, the central axis passing through the above-described vertex is referred to as a reference axis. In FIG. 2, the reference axis is represented as Ax. The shape of the corner cube has a 120 degrees rotational symmetry with respect to the reference axis. In FIG. 2, an incident ray that is parallel to the reference axis and a reflected ray that is similarly parallel to the reference axis are shown.

A cross section that contains the reference axis and is orthogonal to two opposite sides of the regular hexagon is referred to a reference cross section. In FIG. 3, the reference cross section is represented as a broken line. The B-B cross section shown in FIG. 1 is a common reference cross section of the reflector units concerned. In FIG. 3, a distance between the two opposite sides of the regular hexagon is represented as Pr.

The reflector units are arranged in such a way that in a cross section perpendicular to the reference axes, the regular hexagons of the reflector units are arranged without spaces between them. The reference cross sections of the reflector units agree with or are parallel to one another. The B-B cross section shown in FIG. 1 represents one of the reference cross sections.

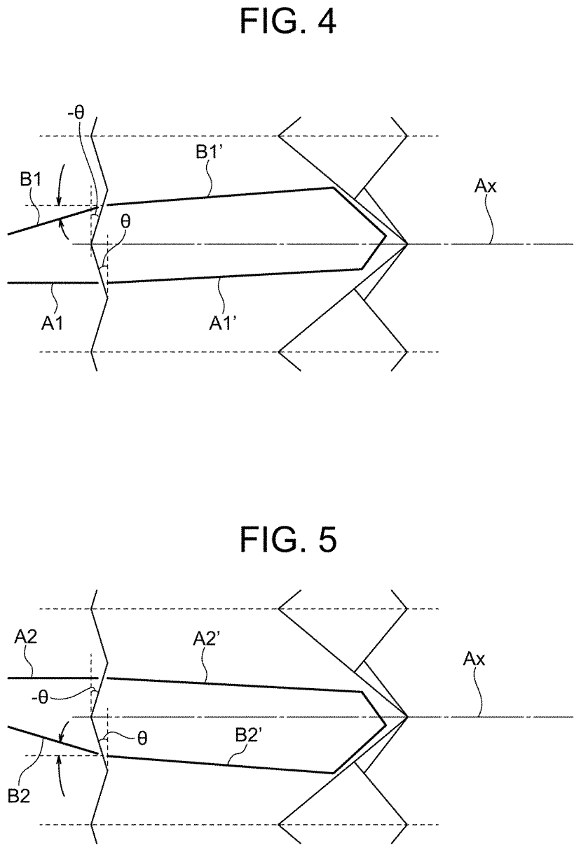

Each of FIG. 4 and FIG. 5 shows the reference cross section of a reflector unit according to an embodiment of the present invention.

In the reference cross section, the shape of a light receiving surface on the opposite side of s reflector unit from the vertex of the corner cube is line-symmetric with respect to the reference axis Ax within the reflector unit. When an angle of the light receiving surface at a first point measured counterclockwise with respect to a direction perpendicular to the reference axis Ax is represented as θ, the shape of the light receiving surface is configured in such a way that an angle of the light receiving surface at a second point that is line-symmetric with the first point with respect to the reference axis Ax measured counterclockwise with respect to a direction perpendicular to the reference axis Ax is −θ. The angle −θ measured counterclockwise is the angle θ measured clockwise. The shape of the light receiving surface is configured so as to be uniform in any cross section parallel to the reference cross section of each reflector unit, and is line-symmetric with respect to the reference axis of each reflector unit. Further, the shape of the corner cube is line-symmetric with respect to the reference axis in a cross section parallel to the reference cross section.

In FIG. 4, an incident ray parallel to the reference axis Ax is represented as A1. An angle of the surface onto which the ray A1 is incident measured counterclockwise form a direction perpendicular to the reference axis Ax is θ. Accordingly, a direction of the incident ray travelling in the reflector unit is not parallel to the reference axis Ax, and forms a first predetermined angle determined by θ and the index of refraction of a material of the reflector unit, with a direction parallel to the reference axis Ax. In FIG. 4, the ray travelling from the light receiving surface to the retroreflective structure is represented as A1′. As described above, the ray reflected by the retroreflective structure is parallel to the ray A1′. In FIG. 4, the reflected ray is represented as B1′. Since θ is a very small angle as described later, the point of intersection of the ray B1′ with the light receiving surface is substantially symmetric with the point of intersection of the ray A1 with the light receiving surface with respect to the reference axis Ax. Accordingly, an angle of the surface that the ray B1′ enters measured counterclockwise with respect to a direction perpendicular to the reference axis Ax is −θ, and an angle measured clockwise is θ. As a consequence, the ray B1 leaving the light receiving surface forms a second predetermined angle with a direction parallel to the reference axis Ax.

In FIG. 5, an incident ray parallel to the reference axis Ax is represented as A2. An angle of the surface onto which the ray A2 is incident measured counterclockwise form a direction perpendicular to the reference axis Ax is −θ, and the angle measured clockwise is θ. Accordingly, a direction of the incident ray travelling in the reflector unit is not parallel to the reference axis Ax, and forms a third predetermined angle determined by θ and the index of refraction of a material of the reflector unit, with a direction parallel to the reference axis Ax. In FIG. 5, the ray travelling from the light receiving surface to the retroreflective structure is represented as A2′. As described above, the ray reflected by the retroreflective structure is parallel to the ray A2′. In FIG. 5, the reflected ray is represented as B2′. Since θ is a very small angle as described later, the point of intersection of the ray B2′ with the light receiving surface is substantially symmetric with the point of intersection of the ray A2 with the light receiving surface with respect to the reference axis Ax. Accordingly, an angle of the surface that the ray B2′ enters measured counterclockwise with respect to a direction perpendicular to the reference axis Ax is θ. As a consequence, the ray B2 leaving the light receiving surface forms a fourth predetermined angle with a direction parallel to the reference axis Ax.

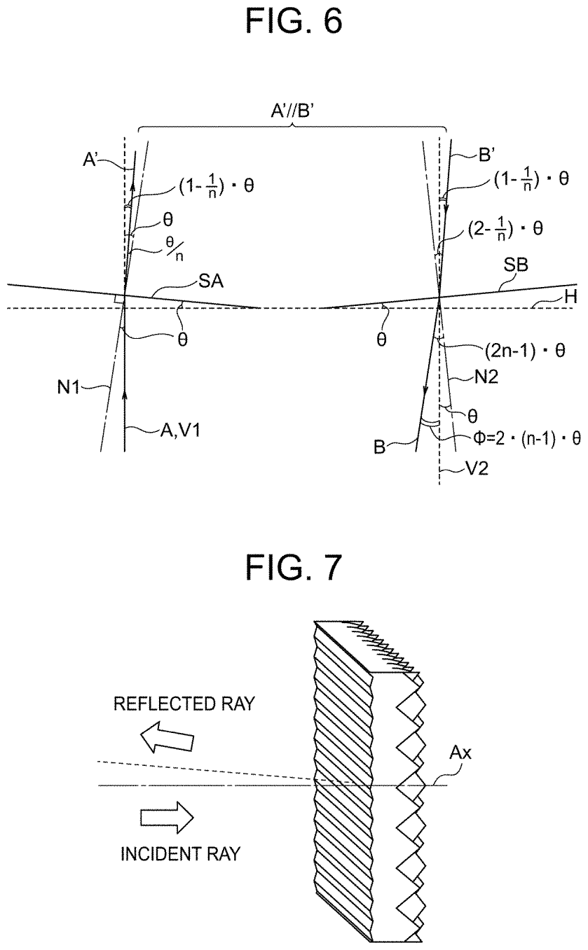

FIG. 6 is a drawing for illustrating an angle of a ray leaving the reflector unit with respect to a direction parallel to the reference axis (the second and fourth predetermined angles described above). FIG. 6 shows the reference cross section. Angles in FIG. 6 are acute ones with positive values, and a negative sign is not used.

In FIG. 6, an incident ray onto the reflector unit is represented as A, a surface onto which the ray A is incident is represented as SA, a normal of the surface SA at the point at which the ray A reaches the surface SA is represented as N1, and the incident ray travelling in the reflector unit is represented as A′. The ray A is parallel to the reference axis. When an angle of the surface SA with respect to a direction perpendicular to the reference axis is represented as θ, the angle of incidence of the ray A is θ. Since θ is very small, the angle of refraction of the ray A′ is expressed by

θ/n

when the index of refraction of a material of the reflector unit is represented as n.

Accordingly, an angle that the ray A forms with the direction of the reference axis Ax is as below.

(1−1/n)·θ

In FIG. 6, the ray that is generated by reflection of the ray A′ in the retroreflective structure is represented as B′, a surface onto which B′ is incident is represented as SB, a normal of the surface SB at the point at which the ray B′ reaches the surface SB unit is represented as N2, and the ray leaving the reflector unit after having passed through the surface SB is represented as B. The angle of the surface SB with respect to a direction perpendicular to the reference axis is θ. The surface SB and the surface SA are tilted in opposite directions with respect to a direction perpendicular to the reference axis. Since the ray B′ is parallel to the ray A′, the angle that the ray B′ forms with the direction (V2) of the reference axis is as below.

(1−1/n)·θ

Accordingly, the angle that the ray B′ forms with N2 is as below.

(2−1/n)·θ

Since θ is very small, the angle of refraction of the ray B′ is as below.

(2·n−1)·θ

Accordingly, the angle that the ray B′ forms with the direction (V2) of the reference axis is as below.

2·(n−1)·θ

As a consequence, the ray A that has traveled in the direction (V1) of the reference axis and has entered the reflector unit is made to travel as the ray B in a direction inclined with respect to the direction (V2) of the reference axis by the following angle after (having been reflected and) having left the reflector unit.

ϕ=2·(n−1)·θ

FIG. 7 is a drawing for illustrating a reflector according to an embodiment of the present invention. As shown in FIG. 7, an incident ray in the direction of the reference axis Ax enters the light receiving surface, is reflected by the retroreflective structure and then is made to travel as a reflected ray that is inclined with respect to the direction of the reference axis Ax by the above-described angle. As described above, the shape of the light receiving surface is uniform in any cross section that agrees with or parallel to the reference cross section of each reflector unit, such as the B-B cross section shown in FIG. 1. In FIG. 7 and other drawings given below, an angle of inclination θ of the light receiving surface with respect to a direction perpendicular to the reference axis is exaggerated compared with the actual angle for the sake of clarity. In fact, as shown in FIG. 1, the shape of the light receiving surface can hardly be distinguished by the unaided eye.

Examples of the present invention will be described below. For data on the dimensions of the reflectors of the examples, the reflector shown in the plan view of FIG. 1 is 27 millimeters wide and 81 millimeters long.

### Example 1

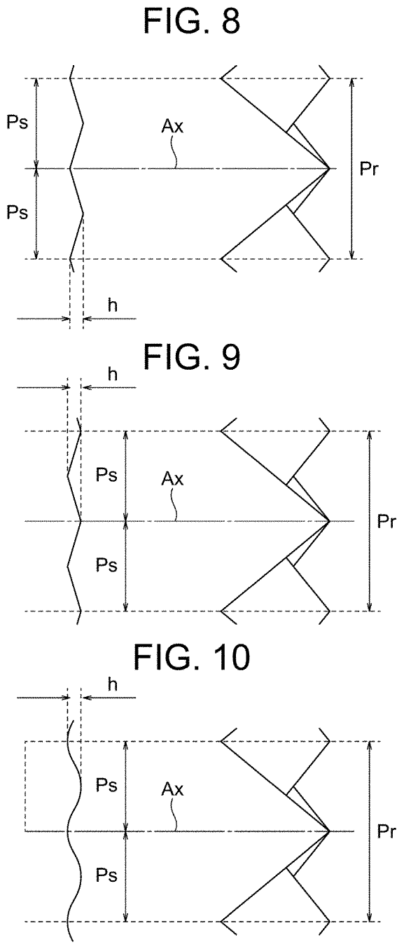

FIG. 8 shows a reference cross section of a reflector unit of Example 1.

In the reference cross section, the shape of a light receiving surface is line-symmetric with respect to the reference axis Ax. The distance Pr between the two opposite sides of the regular hexagon in FIG. 3 is referred to as length of the reflector unit. In the reference cross section, the light receiving surface has the shape of triangular wave that is configured by combining two types of line segments. In the first type, an angle of inclination of each line segment measured counterclockwise with respect to a direction perpendicular to the reference axis Ax is θ, and in the second type, an angle of inclination of each line segment measured clockwise with respect to a direction perpendicular to the reference axis Ax is θ. All the line segments, that is, the sides of triangles are equal in length, and the magnitude of the component of each line segment in a direction of the length of the reflector unit is Ps/2. The height (the length in the direction of the reference axis Ax) of each triangular wave is h.

The shape of the light receiving surface is also referred to as a diffusing structure. The diffusing structure can be recognized as a periodic structure with the period of Ps.

Table 1 gives numerical data of the reflector unit of Example 1.

TABLE 1

| Length Pr of reflector unit | 4 | mm |
|---|---|---|
| Shape of diffusing structure | Shape of triangular wave | |
| Period Ps of diffusing structure | 2 | mm |
| (triangular wave) | | |
| Depth h of diffusing structure (triangular | 3.56 | μm |
| wave) | | |
| Angle of inclination θ of light receiving | 0.204 | degrees |
| surface | | |
| Material of reflector unit | Acryl | |
| Index of refraction n of material | 1.5 | |
| Angle φ of reflected ray with respect to | 0.204 | degrees |
| reference axis direction | | |

As described above, an angle of a reflected ray of light with respect to the direction of the reference axis is expressed as below.

ϕ=2·(n−1)·θ

In general, the length Pr of a reflector unit should preferably range from 0.5 to 10 millimeters, and the angle of inclination θ of a light receiving surface from a direction perpendicular to the reference axis Ax should preferably be 2 degrees or smaller.

As described using FIG. 4 and FIG. 5, when a ray of light is incident on a surface having an angle (an acute angle) of inclination θ measured counterclockwise, the reflected ray forms an angle (an acute angle) ϕ measured counterclockwise with the direction of the reference axis, and when a ray of light is incident on a surface having an angle (an acute angle) of inclination θ measured clockwise, the reflected ray forms an angle (an acute angle) ϕ measured clockwise with the direction of the reference axis. Accordingly, reflected rays of light are generated in two directions.

### Example 2

FIG. 9 shows a reference cross section of a reflector unit of Example 2.

In the reference cross section, the shape of a light receiving surface is line-symmetric with respect to the reference axis Ax. The distance Pr between the two opposite sides of the regular hexagon in FIG. 3 is referred to as length of the reflector unit. In the reference cross section, the light receiving surface has the shape of triangular wave that is configured by combining two types of line segments. In the first type, an angle of inclination of each line segment measured counterclockwise with respect to a direction perpendicular to the reference axis Ax is θ, and in the second type, an angle of inclination of each line segment measured clockwise with respect to a direction perpendicular to the reference axis Ax is θ. All the line segments, that is, the sides of triangles are equal in length, and the magnitude of the component of each line segment in the direction of the length of the reflector unit is Ps/2. The height (the length in the direction of the reference axis Ax) of each triangular wave is h.

The shape of the light receiving surface is also referred to as a diffusing structure. The diffusing structure can be recognized as a periodic structure with the period of Ps.

Table 2 gives numerical data of the reflector unit of Example 2.

TABLE 2

| Length Pr of reflector unit | 4 | mm |
|---|---|---|
| Shape of diffusing structure | Shape of triangular wave | |
| Period Ps of diffusing structure | 2 | mm |
| (triangular wave) | | |
| Depth h of diffusing structure (triangular | 3.56 | μm |
| wave) | | |
| Angle of inclination θ of light receiving | 0.204 | degrees |
| surface | | |
| Material of reflector unit | Acryl | |
| Index of refraction n of material | 1.5 | |
| Angle of reflected ray with respect to | 0.204 | degrees |
| reference axis direction | | |

As described above, an angle of a reflected ray of light with respect to the direction of the reference axis is expressed as below.

ϕ=2·(n−1)·θ

As described using FIG. 4 and FIG. 5, when a ray of light is incident on a surface having an angle (an acute angle) of inclination θ measured counterclockwise, the reflected ray forms an angle (an acute angle) ϕ measured counterclockwise with the direction of the reference axis, and when a ray of light is incident on a surface having an angle (an acute angle) of inclination θ measured clockwise, the reflected ray forms an angle (an acute angle) ϕ measured clockwise with the direction of the reference axis. Accordingly, reflected rays of light are generated in two directions.

### Example 3

FIG. 10 shows a reference cross section of a reflector unit of Example 3.

In the reference cross section, the shape of a light receiving surface is line-symmetric with respect to the reference axis Ax. The distance Pr between the two opposite sides of the regular hexagon in FIG. 3 is referred to as length of the reflector unit. In the reference cross section, the light receiving surface has the shape of sinusoidal wave. The period of the sinusoidal wave is Ps.

The shape of the light receiving surface is also referred to as a diffusing structure. The diffusing structure can be recognized as a periodic structure with the period of Ps.

Table 3 gives numerical data of the reflector unit of Example 3.

TABLE 3

| Length Pr of reflector unit | 4 | mm |
|---|---|---|
| Shape of diffusing structure | Shape of sinusoidal wave | |
| Period Ps of diffusing structure | 2 | mm |
| (sinusoidal wave) | | |
| Value h twice as great as amplitude of | 1.78 | μm |
| diffusing structure (sinusoidal wave) | | |
| Maximum value of angle of inclination | 0.204 | degrees |
| θ of light receiving surface | | |

| | |
|---|---|
| Material of reflector unit | Acryl |
| Index of refraction n of material | 1.5 |

### Performance of the Reflectors of Examples 1-3

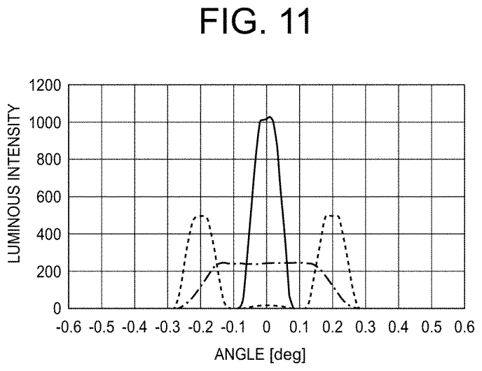

FIG. 11 shows relationships between angle that a reflected ray of an incident ray parallel to the reference axes of a reflector forms with a direction parallel to the reference axes in a reference cross section (for example, B-B cross section in FIG. 1) containing central axes of the reflector and luminous intensity of the reflected ray. The horizontal axis of FIG. 11 indicates angle that a reflected ray of an incident ray parallel to the reference axes of the reflector with the reference axes in the reference cross section described above. The unit of angle is degree. Positive values of angle represent angles measured counterclockwise, and negative values of angle represent angles measured clockwise. The vertical axis of FIG. 11 indicates luminous intensity. The unit of luminous intensity is candela. In all the examples, luminous intensity of the reflected ray is that obtained when a beam is incident on a surface of a reflector such that illuminance on the surface is 18.5 lux. The solid line in FIG. 11 indicates the case that the light receiving surface is flat without a diffusing structure. The direction of the reflected rays is substantially parallel to the reference axes. The broken line in FIG. 11 indicates the cases of Example 1 and Example 2. The angle that the reflected rays form with a direction parallel to the reference axes is substantially −0.2 degrees and +0.2 degrees. The alternative long and short dash line in FIG. 11 indicates the case of Example 3. The angle that the reflected rays form with a direction parallel to the reference axes ranges substantially from −0.25 degrees to 0.25 degrees.

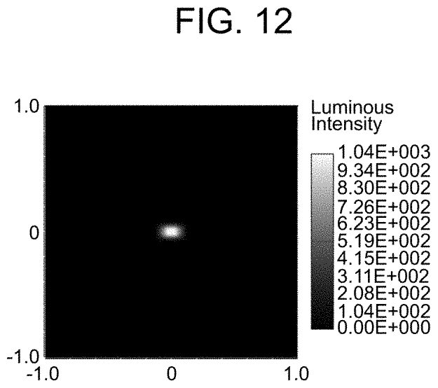

FIG. 12 shows a distribution of luminous intensity of reflected light in the case that the light receiving surface is flat without a diffusing structure. The unit of luminous intensity is candela. The horizontal axis of FIG. 12 indicates angle that a reflected ray of an incident ray parallel to the reference axes of a reflector forms with a direction parallel to the reference axes in a cross section (for example, A-A cross section in FIG. 1) perpendicular to a reference cross section containing central axes of the reflector and luminous intensity of the reflected ray. The vertical axis of FIG. 12 indicates angle that a reflected ray of an incident ray parallel to the reference axes of the reflector forms with a direction parallel to the reference axes in a reference cross section (for example, B-B cross section in FIG. 1) containing central axes of the reflector. The unit of angle is degree.

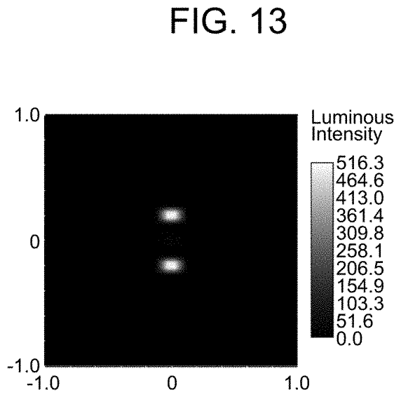

FIG. 13 shows a distribution of luminous intensity of reflected light of Example 1 and Example 2. The unit of luminous intensity is candela. The horizontal axis of FIG. 13 indicates angle that a reflected ray of an incident ray parallel to the reference axes of a reflector forms with a direction parallel to the reference axes in a cross section (for example, A-A cross section in FIG. 1) perpendicular to a reference cross section containing central axes of the reflector and luminous intensity of the reflected ray. The vertical axis of FIG. 13 indicates angle that a reflected ray of an incident ray parallel to the reference axes of the reflector forms with a direction parallel to the reference axes in a reference cross section (for example, B-B cross section in FIG. 1) containing central axes of the reflector. The unit of angle is degree.

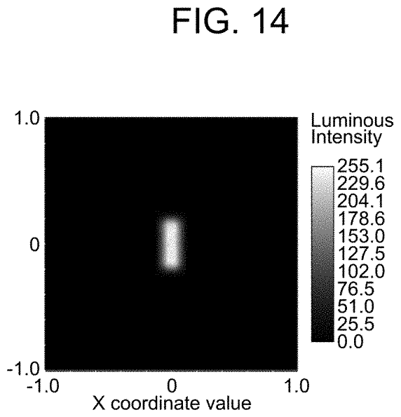

FIG. 14 shows a distribution of luminous intensity of reflected light of Example 3. The unit of luminous intensity is candela. The horizontal axis of FIG. 14 indicates angle that a reflected ray of an incident ray parallel to the reference axes of the reflector forms with a direction parallel to the reference axes in a cross section (for example, A-A cross section in FIG. 1) perpendicular to a reference cross section containing central axes of the reflector and luminous intensity of the reflected ray. The vertical axis of FIG. 14 indicates angle that a reflected ray of an incident ray parallel to the reference axes of the reflector forms with a direction parallel to the reference axes in a reference cross section (for example, B-B cross section in FIG. 1) containing central axes of the reflector. The unit of angle is degree.

### Example 4

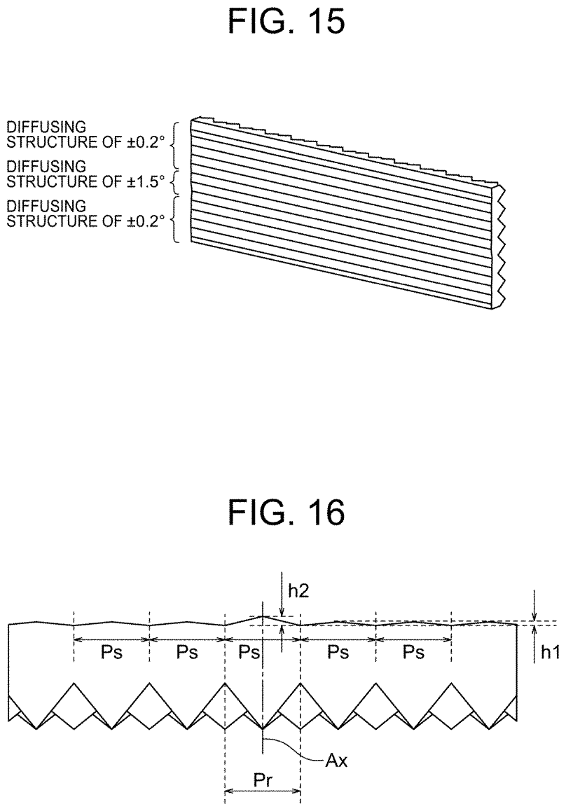

FIG. 15 is a drawing for illustrating a reflector of Example 4. The reflector of Example 4 is provided with two types of diffusing structures, a diffusing structure 1 and a diffusing structure 2. With the diffusing structure 1, the angle that a reflected lay forms with the direction of the reference axes is ±0.2 degrees, and with the diffusing structure 2, the angle described above is ±1.5 degree.

FIG. 16 shows a common reference cross section of plural reflector units provided with the two types of diffusing structures of Example 4. In FIG. 16, the single reflector unit having the reference axis represented by the alternate long and short dash line has the diffusing structure 2, and each of the other reflector units has the diffusing structure 1.

In the reference cross section described above, the shape of the light receiving surface in each reflector unit is line-symmetric with respect to each reference axis. The distance Pr between the two opposite sides of the regular hexagon in FIG. 3 is referred to as length of the reflector unit. In the reference cross section described above, the light receiving surface has the shape of triangular wave that is configured by combining two types of line segments. In the first type an angle of inclination of each line segment measured counterclockwise with respect to a direction perpendicular to the reference axis Ax is θ1 or θ2, and in the second type, an angle of inclination of each line segment measured clockwise with respect to a direction perpendicular to the reference axis Ax is θ1 or θ2. The magnitude of the component of each line segment in the direction of the length of the reflector unit is Ps/2. The height (the length in the direction of the reference axis Ax) of each triangular wave is h1 or h2.

Table 4 gives numerical data of the reflector unit of Example 4.

TABLE 4

| Length Pr of reflector unit | 4 | mm |
|---|---|---|
| Shape of diffusing structure 1 | Shape of triangular wave | |
| Period Ps of diffusing structure 1 | 4 | mm |
| (triangular wave) | | |
| Depth h1 of diffusing structure 1 | 7.12 | μm |
| (triangular wave) | | |
| Angle of inclination θ1 of light | 0.204 | degrees |
| receiving surface | | |
| Shape of diffusing structure 2 | Shape of triangular wave | |
| Period Ps of diffusing structure 2 | 4 | mm |
| (triangular wave) | | |
| Depth h2 of diffusing structure 2 | 53.4 | μm |
| (triangular wave) | | |
| Angle of inclination θ2 of light | 1.53 | degrees |
| receiving surface | | |
| Material of reflector unit | Acryl | |
| Index of refraction n of material | 1.5 | |
| Angle of reflected ray with respect to | 0.204 | degrees |
| reference direction in diffusing | | |
| structure 1 | | |
| Angle of reflected ray with respect to | 1.53 | degrees |
| reference direction in diffusing | | |
| structure 2 | | |

As described above, an angle of a reflected ray of light with respect to the direction of the reference axis is expressed as below.

ϕ=2·(n−1)·θ

As described using FIG. 4 and FIG. 5, when a ray of light is incident on a surface having an angle (an acute angle) of inclination θ measured counterclockwise, the reflected ray forms an angle (an acute angle) ϕ measured counterclockwise with the direction of the reference axis, and when a ray of light is incident on a surface having an angle (an acute angle) of inclination θ measured clockwise, the reflected ray forms an angle (an acute angle) ϕ measured clockwise with the direction of the reference axis. Accordingly, reflected rays of light are generated in two directions by each diffusing structure.

### Performance of the Reflector of Example 4

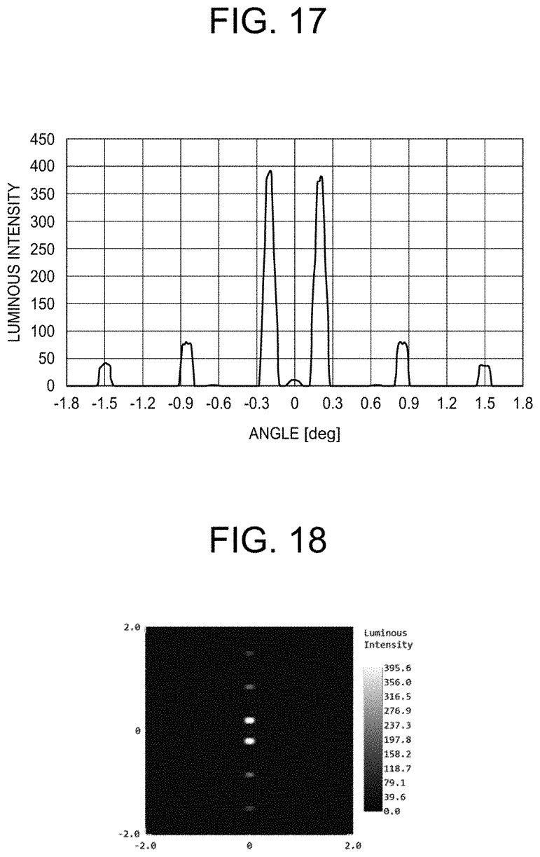

FIG. 17 shows relationships between angle that a reflected ray of an incident ray parallel to the reference axes of the reflector forms with a direction parallel to the reference axes in a reference cross section containing central axes of the reflector and luminous intensity of the reflected ray. The horizontal axis of FIG. 17 indicates angle that a reflected ray of an incident ray parallel to the reference axes of the reflector with the reference axes in the reference cross section described above. The unit of angle is degree. Positive values of angle represent angles measured counterclockwise, and negative values of angle represent angles measured clockwise. The vertical axis of FIG. 17 indicates luminous intensity. The unit of luminous intensity is candela. In FIG. 17, reflected rays that form substantially −0.2 degrees and +0.2 degrees with a direction parallel to the reference axes, the rays having been generated by the diffusing structure 1 and reflected rays that form −1.5 degrees and +1.5 degrees with a direction parallel to the reference axes, the rays having been generated by the diffusing structure 2 can be observed.

In FIG. 17, besides the reflected rays that form the angles described above with a direction parallel to the reference axes, reflected rays that form −0.85 degrees and +0.85 degrees with a direction parallel to the reference axes can be observed. The reason is as below. At the boundaries of the diffusing structure 1 and the diffusing structure 2, there exist reflector units, each of which contains a portion of the light receiving surface of the diffusing structure 1 and a portion of the light receiving surface of the diffusing structure 2, and the shape of the light receiving surface of each is not line-symmetric with respect to the reference axis. These reflector units generate the reflected rays that form −0.85 degrees and +0.85 degrees with a direction parallel to the reference axis.

In general, luminous intensity of reflected rays generated by a diffusing structure is in proportion to the number of the reflector units provided with the diffusing structure. Accordingly, when the number of reflector units provided with the diffusing structures 1 and reflector units provided with reflector units provided with the diffusing structures 2 is increased, luminous intensity of reflected rays generated by reflector units at the boundaries between the diffusing structure 1 and the diffusing structure 2, the shape of the light receiving surface in each of the reflector units being not line-symmetric with respect to each reference axis, can be made relatively small.

FIG. 18 shows a distribution of luminous intensity of reflected light of Example 4. The unit of luminous intensity is candela. The horizontal axis of FIG. 18 indicates angle that a reflected ray of an incident ray parallel to the reference axes of the reflector forms with a direction parallel to the reference axes in a cross section (for example, A-A cross section in FIG. 1) perpendicular to a reference cross section containing central axes of the reflector and luminous intensity of the reflected ray. The vertical axis of FIG. 18 indicates angle that a reflected ray of an incident ray parallel to the reference axes of the reflector forms with a direction parallel to the reference axes in a reference cross section (for example, B-B cross section in FIG. 1) containing central axes of the reflector. The unit of angle is degree.

### OTHER EMBODIMENTS

In the embodiments and examples described above, a corner cube is used as a retroreflective structure. As a retroreflective structure, another structure, for example a ball lens can be used. Plural reflector units, each being provided with a ball lens as a retroreflective structure, are arranged in such a way that reference cross sections of respective reflector units agree with or are parallel to one another. The light receiving surface is shaped in such a way that the shape is uniform in the cross section of any reflector unit and cross sections that are parallel to the cross section and is line-symmetric within any reflector unit with respect to the reference axis of the reflector unit.

Even when a ball lens is used as a retroreflective structure, similarly to Examples 1-4, an angle of a reflected ray of light with respect to the direction of the reference axes is determined by the following expression containing an angle of inclination θ of the light receiving surface and the index of refraction of a material of the reflector units.

ϕ=2·(n−1)·θ

What is claimed is:

1. A reflector provided with plural reflector units, wherein each reflector unit is shaped as a prism or a cylinder provided with a retroreflective structure at one end, the retroreflective structure is configured to reflect incident rays from the other end of the prism or the cylinder in a direction of incidence, and in a reference cross section of the reflector unit, the reference cross section containing the central axis of the prism or the cylinder and the reference cross section being determined such that the shape of the retroreflective structure is line-symmetric with respect to the central axis in the reference cross section, the shape of a light receiving surface at the other end is line-symmetric with respect to the central axis and has a portion inclined with respect to a direction perpendicular to the central axis in the reflector unit.

2. The reflector according to claim 1, wherein in the reference cross section of each reflector unit, when an angle measured counterclockwise that the light receiving surface forms with a direction perpendicular to the central axis at a first point on the light receiving surface is represented as θ, an angle measured clockwise that the light receiving surface forms with a direction perpendicular to the central axis at a second point on the light receiving surface, the first point and the second point being line-symmetric with respect to the central axis, is θ, and the reflector unit is configured to reflect incident rays onto the prism or the cylinder in a direction inclined with respect to the central axis by an angle determined depending on θ.

3. The reflector according to claim 1, wherein at least a certain number of the plural reflector units are combined with one another such that respective reference cross sections agree with or are made parallel to one another, and the shape of the light receiving surface is uniform in the reference cross section of any reflector unit of the certain number of the plural reflector units and in cross sections parallel to the reference cross section.

4. The reflector according to claim 1, wherein each reflector unit is provided with a corner cube as a retroreflective structure at one end of the prism having a cross section in the shape of a regular hexagon, and the reference cross section of the reflector is determined to be orthogonal to two opposite sides of the regular hexagon.

5. The reflector according to claim 1, wherein each reflector unit is provided with a ball lens as a retroreflective structure at one end of the cylinder.

6. The reflector according to claim 1, wherein in the reference cross section, the shape of the light receiving surface in each reflector unit is a combination of line segments, the combination being line-symmetric with respect to the central axis.

7. The reflector according to claim 1, wherein in the reference cross section, the shape of the light receiving surface in each reflector unit is a curve that is line-symmetric with respect to the central axis.

8. The reflector according to claim 1, comprising plural types of light receiving surfaces that are differently shaped.
